(19) United States
(12) Patent Application Publication
(10) Pub. No.: US 2011/0096845 A1
(43) Pub. Date: Apr. 28, 2011

(54) METHOD AND SYSTEM FOR PROVIDING DECOUPLED STREAMS FOR CLOCK RECOVERY AND DECODING

(76) Inventor: Rajesh Mamidwar, San Diego, CA (US)

(21) Appl. No.: 12/603,784

(22) Filed: Oct. 22, 2009

(51) Int. Cl. H04N 11/02

(52) U.S. Cl. 375/240.26; 375/E07.026

(57) ABSTRACT

A receiver may be operable to determine a clock reference (CR) such as a MPEG program clock reference (PCR) associated with a first program CR packet identifier (PID), recover a locked oscillator and a system time clock (STC) from the clock reference associated with the first program CR packet identifier (PID) and process content associated with a second program utilizing the recovered locked oscillator and the system time clock. The receiver may be operable to insert the content associated with the second program on the content associated with the first program CR PID. The receiver may be operable to receive the content associated with the second program from a source that is local to the receiver such as a hard disk or a flash drive or from a source that is remote with respect to the receiver.

### CROSS-REFERENCE TO RELATED APPLICATIONS/INCORPORATION BY REFERENCE

[Not applicable]

### FIELD OF THE INVENTION

Certain embodiments of the invention relate to data processing. More specifically, certain embodiments of the invention relate to a method and system for providing decoupled streams for clock recovery and decoding.

### BACKGROUND OF THE INVENTION

MPEG-2 is a standard for the generic coding of moving pictures and associated audio information. MPEG-2, which was the second of several standards developed by the moving pictures expert group (MPEG), is widely used as the format of digital television signals that are broadcast, for example, by terrestrial (over-the-air), cable and direct broadcast satellite TV systems. It also specifies the format of movies and other programs that are distributed on DVD and similar discs.

An output stream of an audio or video encoder is called an elementary stream (ES) such as an encoded video ES (or encoded video stream), an encoded audio ES (or encoded audio stream), respectively. The length of an ES may be variable and may be as long as the program itself. Each elementary stream may be broken into a plurality of convenient-sized data blocks in a packetized elementary stream (PES). For transmission and digital broadcasting, several programs and their associated PES may be multiplexed into a single transport stream (TS). The transport stream (TS) offers features for error correction for carrying digital video and audio over possibly unreliable media, such as broadcasting or internet protocol (IP) data networks, examples of which include ATSC, DVB and SBTVD. A transport stream (TS) further subdivides PES packets into short fixed-size packets. Each packet carries a packet identifier (PID), which plays a key role in the operation of the transport stream (TS). Packets in the same elementary stream all have the same PID. This may enable a MPEG-2 decoder or receiver to select the elementary stream(s) of a program such as, for example, a TV channel it wants based on their corresponding PIDs.

The elementary streams (ESs) of each program are encoded in relation to a single encoder system time clock (STC) such as, in MPEG-2, the 90 KHz clock that is derived from a 27 MHz oscillator or clock. To assist the decoder or receiver in presenting programs in a timely manner, at the right speed, and with proper synchronization, programs usually periodically provide a clock reference (CR), for example, a program clock reference (PCR) on one of the PIDs in the program. The decoder or receiver may be able to recover the original encoder STC to decode or process each ES and present each decoded ES in timely and mutually synchronized fashion. PCRs, which are time stamps in the transport stream (TS), may be inserted, for example, with a maximum interval of 100 msec. A MPEG-2 decoder or receiver may extract PCRs from the transport stream and employs a PCR clock recovery mechanism such as a phase-locked loop (PLL) method to synchronize the decoder or receiver STC with the encoder STC.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for providing decoupled streams for clock recovery and decoding, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an exemplary MPEG-2 signal processing system that is operable to decouple streams for clock recovery and decoding, in accordance with an embodiment of the invention.

FIG. 2 is a block diagram illustrating an exemplary receiver that is operable to decouple streams for clock recovery and decoding, in accordance with an embodiment of the invention.

FIG. 3 is a block diagram illustrating an exemplary decoding module that is operable to decouple streams for clock recovery and decoding, in accordance with an embodiment of the invention.

FIG. 4 is a block diagram illustrating an exemplary extraction of a program clock reference (PCR) from a transport stream packet, in accordance with an embodiment of the invention.

FIG. 5 is a flow chart illustrating exemplary steps for inserting local content on a TV channel program, in accordance with an embodiment of the invention.

FIG. 6 is a flow chart illustrating exemplary steps for decoupling streams for clock recovery and decoding, in accordance with an embodiment of the invention.

### DETAILED DESCRIPTION OF THE INVENTION

Certain embodiments of the invention can be found in a method and system for providing decoupled streams for clock recovery and decoding. In various embodiments of the invention, a receiver may be operable to determine a clock reference (CR) associated with a first program CR packet identifier (PID), recover a locked oscillator and a system time clock (STC) from the determined clock reference associated with the first program CR packet identifier (PID) and process content associated with a second program utilizing the recovered locked oscillator and the system time clock. In this regard, the receiver may be operable to process content associated with the first program CR PID utilizing the recovered locked oscillator and the system time clock and insert the content associated with the second program on content associated with the first program CR PID. The receiver may be operable to receive the content associated with the second program from a source that is local to the receiver. In this regard, the source that is local to the receiver may comprise a local storage within the receiver such as a hard disk or a local storage that is coupled to the receiver such as a flash drive. The receiver may also be operable to receive the content associated with the second program from a source that is remote with respect to the receiver. The determined clock reference may comprise a MPEG program clock reference (PCR). The receiver may be operable to extract the clock reference from a MPEG transport stream.

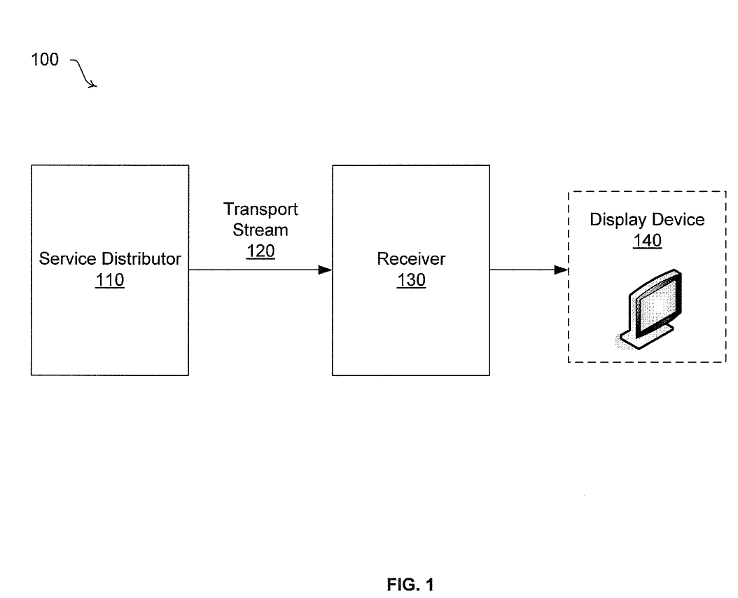

FIG. 1 is a block diagram illustrating an exemplary MPEG-2 signal processing system that is operable to decouple streams for clock recovery and decoding, in accordance with an embodiment of the invention. Referring to FIG. 1, there is shown a MPEG-2 signal processing system 100. The MPEG-2 signal processing system 100 may comprise a service distributor 110, a transport stream 120, a receiver 130 and a display device 140.

The service distributor 110 may comprise suitable logic, circuitry, interfaces and/or code that may be operable to distribute content for MPEG, for example, MPEG-2 services or programs via a transport stream 120 to the receiver 130. The service distributor 110 such as, for example, a headend system may be operable to provide various services such as, for example, distribution, multicast, and/or quality of service necessary for a reliable and timely transmission of content for the MPEG, for example, the MPEG-2 services or programs to the receiver 130. The service distributor 110 may be operable to utilize, for example, a cable TV network, satellite broadcasting network, the Internet protocol (IP) data network such as the Internet, and/or a wireless communication network for delivery of the MPEG, for example, the MPEG-2 services or content to the receiver 130. The service distributor 110 may be operable to encode elementary streams (ESs) of each program in relation to a single encoder system time clock (STC) such as the 90 KHz clock that may be derived from a 27 MHz oscillator or clock. The service distributor 110 may be operable to provide the clock reference (CR) on one of the program CR PIDs, for example, the program clock reference (PCR) on one of the MPEG-2 transport PCR PIDs such as a video stream, an audio stream or an independent PID packet stream in the transport stream 120 to the receiver 130. The CR or the PCR may be extracted from the transport stream 120 by the receiver 130 for recovering the locked oscillator and the system time clock (STC).

The receiver 130 may comprise suitable logic, circuitry, interfaces and/or code that may be operable to receive the transport stream 120 from the service distributor 110. The receiver 130 such as, for example, a set-top box may be operable to extract individual programs (or program streams) in the received transport stream 120 and de-multiplex the received program into video, audio, Internet protocol (IP) data stream and/or other elementary streams (ESs) based on corresponding packet identifiers (PIDs). The receiver 130 may be operable to extract a clock reference (CR) from one of the program CR PID packets, for example, a program clock reference (PCR) from one of the MPEG-2 transport PCR PID packets in the received transport stream 120. The CR or the PCR may be extracted, for example, from a video stream, an audio stream or an independent PID packet stream. The receiver 130 may be operable to recover a locked oscillator such as, in MPEG-2, a 27 MHz oscillator and a system time clock (STC) such as, in MPEG-2, a 90 KHz clock using the received PCR and a PCR clock recovery mechanism. The receiver 130 may be operable to decode or process the individual stream such as, for example, the video stream, the audio stream and/or the Internet protocol (IP) data stream using the recovered locked oscillator and STC. The decoding module 230 may be operable to present the processed or decoded programs to the display device 140.

In an exemplary embodiment of the invention, the receiver 130 may be operable to insert content or a program on received TV channel program for a period of time. The inserted content or program may be, for example, a locally recorded commercial (local content) from a storage device such as, for example, a hard disk within the receiver 130 or a flash drive that is coupled to the receiver 130 or a commercial remotely from a different TV channel program. Instead of processing the inserted local content or commercial using the fixed clock running from the local crystal in the receiver 130, the receiver 130 may be operable to process the inserted local content or commercial using the current recovered locked oscillator and STC of the original received TV channel program during the time when the inserted local content or commercial is played. Instead of processing the inserted content or commercial remotely from a different TV channel program using the corresponding recovered locked oscillator and STC of that different TV channel program, the receiver 130 may be operable to process the inserted content or commercial using the current recovered locked oscillator and STC of the original received TV channel program during the time when the inserted content or commercial is played. In this regard, glitches at the end of each switchover point between the inserted content or program and the TV channel program may be eliminated.

In an exemplary embodiment of the invention, the receiver 130 may also be operable to process content or a program such as, for example, audio content and/or video content associated with a TV channel program, an Internet protocol (IP) data or local content from a storage device using a locked oscillator or clock which may be recovered using a PCR extracted from a different program. This different program may be, for example, either broadcast content in the transport stream 120 or pre-recorded local content during a personal video recorder (PVR) playback.

The display device 140 may comprise suitable logic, circuitry, interfaces and/or code that may be operable to display or present processed or decoded content or programs to users.

In operation, the receiver 130 may be operable to receive the transport stream 120 form the service distributor 110. The receiver 130 may be operable to extract individual programs (or program streams) in the received transport stream 120 and de-multiplex the received program into video, audio, Internet protocol (IP) data stream and/or other elementary streams (ESs) based on corresponding packet identifiers (PIDs). The receiver 130 may be operable to extract a program clock reference (PCR) from one of the transport PCR PID packets in the received transport stream 120. The PCR may be extracted, for example, from a video stream, an audio stream or an independent PID packet stream. The receiver 130 may be operable to recover the locked oscillator and the system time clock (STC) using the received PCR and a PCR clock recovery mechanism. The receiver 130 may be operable to decode or process the individual stream such as, for example, the video stream, the audio stream and/or the Internet protocol (IP) data stream using the recovered locked oscillator and STC. The receiver 130 may be operable to communicate the processed or decoded content or programs to the display device 140 for presentation.

The receiver 130 may be operable to insert content or a program on the received TV channel program for a period of time. The inserted content or program may be, for example, a locally recorded commercial (local content) from a storage device within or coupled to the receiver 130 or a commercial remotely from a different TV channel program. The receiver 130 may be operable to process the inserted content or commercial using the current recovered locked oscillator and STC during the time when the inserted content or commercial is played. The receiver 130 may also be operable to process content or a program such as, for example, a TV channel program, an Internet protocol (IP) data or local content from a storage device using a locked oscillator or clock which may be recovered using a PCR extracted from a different program.

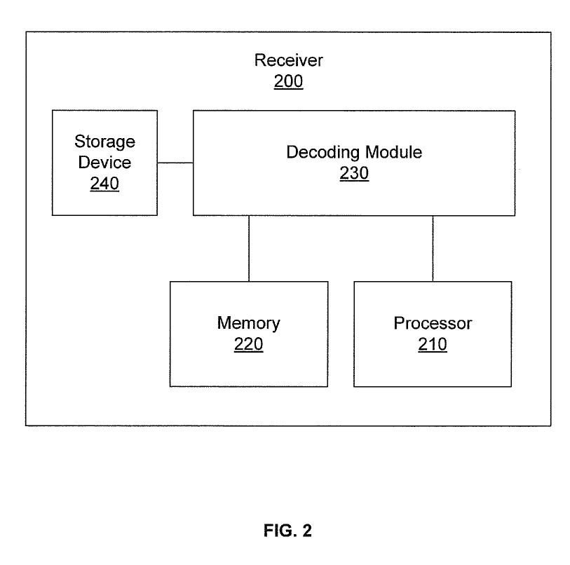

FIG. 2 is a block diagram illustrating an exemplary receiver that is operable to decouple streams for clock recovery and decoding, in accordance with an embodiment of the invention. Referring to FIG. 2, there is shown receiver 200. The receiver 200 may comprise a processor 210, a memory 220 a decoding module 230 and a storage device 240.

The processor 210 may comprise suitable logic, circuitry, interfaces and/or code that may be operable to communicate with the decoding module 230 to perform the processing or decoding functions of the receiver 200.

The memory 220 may comprise suitable logic, circuitry, interfaces and/or code that may be operable to store information such as executable instructions and data that may be utilized by the processor 210 and the decoding module 230 to perform the processing or decoding functions of the receiver 200.

The decoding module 230 may comprise suitable logic, circuitry, interfaces and/or code that may be operable to receive the transport stream 120. The decoding module 230 may be operable to extract individual programs (or program streams) in the received transport stream 120 and de-multiplex the received program into video, audio, Internet protocol (IP) data stream and/or other elementary streams (ESs) based on corresponding packet identifiers (PIDs). The decoding module 230 may be operable to extract a clock reference (CR) from one of the program CR PID packets, for example, a program clock reference (PCR) from one of the MPEG-2 transport PCR PID packets in the received transport stream 120. The CR or the PCR may be extracted, for example, from a video stream, an audio stream or an independent PID packet stream. The decoding module 230 may be operable to recover a locked oscillator such as, in MPEG-2, a 27 MHz oscillator and the system time clock (STC) such as, in MPEG-2, the 90 KHz clock using the received PCR and a PCR clock recovery mechanism. The decoding module 230 may be operable to decode or process the individual stream such as, for example, the video stream, the audio stream and/or the Internet protocol (IP) data stream using the recovered locked oscillator and STC. The decoding module 230 may be operable to communicate the processed or decoded programs to the display device 140 for presentation.

In an exemplary embodiment of the invention, the decoding module 230 may be operable to insert content or a program on the received TV channel program for a period of time. The inserted content or program may be, for example, a locally recorded commercial (local content) from the storage device 240 such as, for example, a hard disk or a flash drive or a commercial remotely from a different TV channel program. Instead of processing the inserted local content or commercial using the fixed clock running from the local crystal in the decoding module 230, the decoding module 230 may be operable to process the inserted local content or commercial using the current recovered locked oscillator and STC of the original received TV channel program during the time when the inserted local content or commercial is played. Instead of processing the inserted content or commercial remotely from a different TV channel program using the corresponding recovered locked oscillator and STC of that different TV channel program, the decoding module 230 may be operable to continue processing of the inserted content or commercial using the current recovered locked oscillator and STC of the original received TV channel program during the time when the inserted content or commercial is played. In this regard, glitches at the end of each switchover point between the inserted content or program and the TV channel program may be eliminated. For example, if a 30-second or a fixed time content or program from a different TV channel program or a local hard disk is inserted on the original received TV channel program continuing using the current recovered locked oscillator and STC of the original received TV channel program, timeline for the original and the inserted program is the same to avoid glitches.

In an exemplary embodiment of the invention, the decoding module 230 may also be operable to process content or a program such as, for example, audio content and/or video content associated with a TV channel program, an Internet protocol (IP) data or local content from the storage device 240 using a locked oscillator or clock which may be recovered using a PCR extracted from a different program. This different program may be, for example, either broadcast content in the transport stream 120 or pre-recorded local content during a PVR playback.

The storage device 240 may comprise suitable logic, circuitry, interfaces and/or code that may be operable to store local contents or programs for playing. The storage device 240 may comprise, for example, a hard disk, a flash drive or other non-volatile storage device. The local content or program such as, for example, a local commercial may be inserted on a TV channel program for playing for a period of time.

In operation, the decoding module 230 may be operable to receive the transport stream 120. The decoding module 230 may be operable to extract individual programs (or program streams) in the received transport stream 120 and de-multiplex the received program into video, audio, Internet protocol (IP) data stream and/or other elementary streams (ESs) based on corresponding packet identifiers (PIDs). The decoding module 230 may be operable to extract a program clock reference (PCR) from one of the transport PCR PID packets in the received transport stream 120. The PCR may be extracted, for example, from a video stream, an audio stream or an independent PID packet stream. The decoding module 230 may be operable to recover the locked oscillator and the system time clock (STC) using the received PCR and a PCR clock recovery mechanism. The decoding module 230 may be operable to decode or process the individual stream such as, for example, the video stream, the audio stream and/or the Internet protocol (IP) data stream using the recovered locked oscillator and STC. The decoding module 230 may be operable to present the processed or decoded programs to the display device 140.

The decoding module 230 may be operable to insert content or a program on the received TV channel program for a period of time. The inserted content or program may be, for example, a locally recorded commercial (local content) from the storage device 240 or a commercial remotely from a different TV channel program. The decoding module 230 may be operable to continue processing of the inserted content or commercial using the current recovered locked oscillator and STC of the original received TV channel program during the time when the inserted content or commercial is played. The decoding module 230 may also be operable to process content or a program such as, for example, a TV channel program, an Internet protocol (IP) data or local content from the storage device 240 using a locked oscillator or clock which may be recovered using a PCR extracted from a different program.

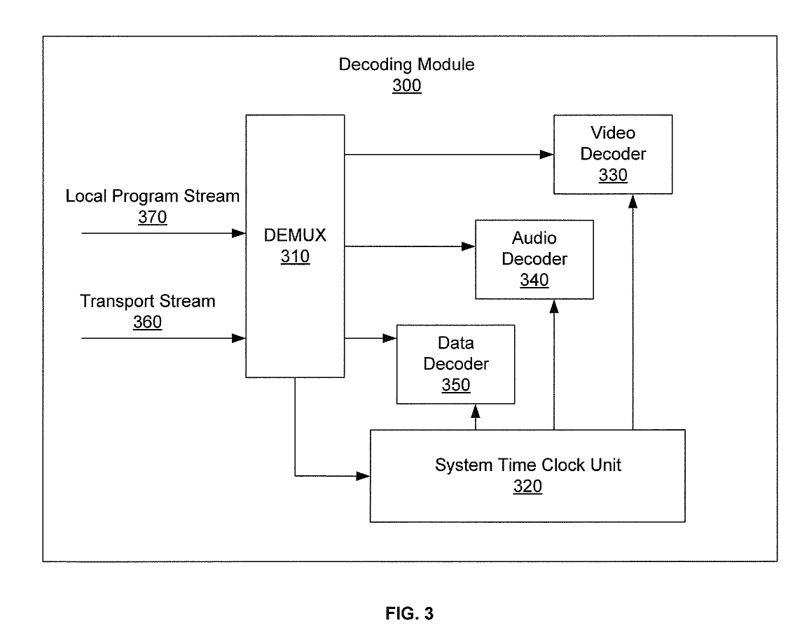

FIG. 3 is a block diagram illustrating an exemplary decoding module that is operable to decouple streams for clock recovery and decoding, in accordance with an embodiment of the invention. Referring to FIG. 3, there is shown a decoding module 300. The decoding module 300 may comprise a DEMUX (de-multiplexer) 310, a system time clock unit 320, a video decoder 330, an audio decoder 340, a data decoder 350, a transport stream 360 and a local program stream 370.

The DEMUX 310 may comprise suitable logic, circuitry, interfaces and/or code that may be operable to receive the transport stream 360 and/or the local program stream 370. The DEMUX 310 may be operable to extract individual programs (or program streams) in the received transport stream 360 and de-multiplex the received program into video, audio, Internet protocol (IP) data stream and/or other elementary streams (ESs) based on corresponding packet identifiers (PIDs). The DEMUX 310 may be operable to extract a clock reference (CR) from one of the program CR PID packets, for example, a program clock reference (PCR) from one of the MPEG-2 transport PCR PID packets in the received transport stream 360. The CR or the PCR may be extracted, for example, from a video stream, an audio stream or an independent PID packet stream. The local program stream 370 may comprise, for example, a local commercial or content stored in the storage device 240. The DEMUX 310 may be operable to extract a clock reference (CR) from, for example, pre-recorded content in the local program stream 370 during a PVR playback. The DEMUX 310 may be operable to insert a local program stream 370 on the received TV channel program in the received transport stream 360 for a period of time. The DEMUX 310 may also be operable to insert content, for example, a commercial from a different TV channel program on the received TV channel program in the received transport stream 360 for a period of time.

The system time clock unit 320 may comprise suitable logic, circuitry, interfaces and/or code that may be operable to receive the extracted clock reference, for example, the PCR. The system time clock unit 320 may be operable to recover a locked oscillator such as, in MPEG-2, a 27 MHz oscillator and a system time clock (STC) such as, in MPEG-2, the 90 KHz clock using the received PCR and a PCR clock recovery mechanism such as, for example, a phase-locked loop (PLL) method. The system time clock unit 320 may be operable to generate or provide various clocks based on the recovered locked oscillator and STC to the video decoder 330, the audio decoder 340 and the data decoder 350 for processing or decoding corresponding streams. The system clock unit 320 may be operable to provide the fixed clock running from the local crystal to the video decoder 330 and the audio decoder 340 for processing or decoding the local program stream 370. During the time when a local program stream 370 may be inserted on the received TV channel program in the received transport stream 360 for a period of time, the system time clock unit 320 may be operable to continue providing clocks based on the current recovered locked oscillator and STC. During the time when content or commercial from different TV channel program may be inserted on the received TV channel program in the transport stream 360 for a period of time, the system time clock unit 320 may be operable to continue providing clocks based on the current recovered locked oscillator and STC. The system time clock unit 320 may also be operable to provide clocks based on the current recovered locked oscillator and STC to different programs in the transport stream 360 such as, for example, a different TV channel program or Internet protocol (IP) data stream.

The video decoder 330 may comprise suitable logic, circuitry, interfaces and/or code that may be operable to process or decode the video stream from the DEMUX 310 using the clock generated or provided by the system time clock unit 320. The processed or decoded video stream may be presented at the display device 140.

The audio decoder 340 may comprise suitable logic, circuitry, interfaces and/or code that may be operable to process or decode the audio stream from the DEMUX 310 using the clock generated or provided by the system time clock unit 320. The processed or decoded audio stream may be presented at the display device 140.

The data decoder 350 may comprise suitable logic, circuitry, interfaces and/or code that may be operable to process or decode the data stream such as, for example, the Internet protocol (IP) data stream from the DEMUX 310 using the clock generated or provided by the system time clock unit 320. The processed or decoded Internet protocol (IP) data stream may be used for various Internet protocol (IP) applications.

In operation, the DEMUX 310 may be operable to receive the transport stream 360. The DEMUX 310 may be operable to extract individual programs (or program streams) in the received transport stream 360 and de-multiplex the received program into video, audio, Internet protocol (IP) data stream and/or other elementary streams (ESs) based on corresponding packet identifiers (PIDs). The DEMUX 310 may be operable to extract a program clock reference (PCR) from one of the transport PCR PIDs in the received transport stream 360. The PCR may be extracted, for example, from a video stream, an audio stream or an independent PID packet stream. The DEMUX 310 may be operable to extract a clock reference (CR) from, for example, pre-recorded content in the local program stream 370 during a PVR playback. The system time clock unit 320 may be operable to recover the locked oscillator and the system time clock (STC) using the received PCR and a PCR clock recovery mechanism. The video decoder 330 may be operable to decode or process the video stream using the clock generated or provided by the system time clock unit 320 and present the processed or decoded video stream at the display device 140. The audio decoder 340 may be operable to decode or process the audio stream using the clock generated or provided by the system time clock unit 320 and present the processed or decoded audio stream at the display device 140. The data decoder 350 may be operable to decode or process the Internet protocol (IP) data stream using the clock generated or provided by the system time clock unit 320.

The DEMUX 310 may be operable to insert content or a program on the received TV channel program in the received transport stream 360 for a period of time. The inserted content or program may be, for example, a local program stream 370 or a commercial from a different TV channel program. During the time when a local program stream 370 may be inserted on the received TV channel program in the received transport stream 360, the system time clock unit 320 may be operable to continue providing clocks based on the current recovered locked oscillator and STC. During the time when content or commercial from different TV channel program may be inserted on the received TV channel program in the transport stream 360 for a period of time, the system time clock unit 320 may be operable to continue providing clocks based on the current recovered locked oscillator and STC. The system time clock unit 320 may also be operable to provide clocks based on the current recovered locked oscillator and STC to different programs in the transport stream 360 such as, for example, a different TV channel program, an Internet protocol (IP) data or local content from the storage device 240.

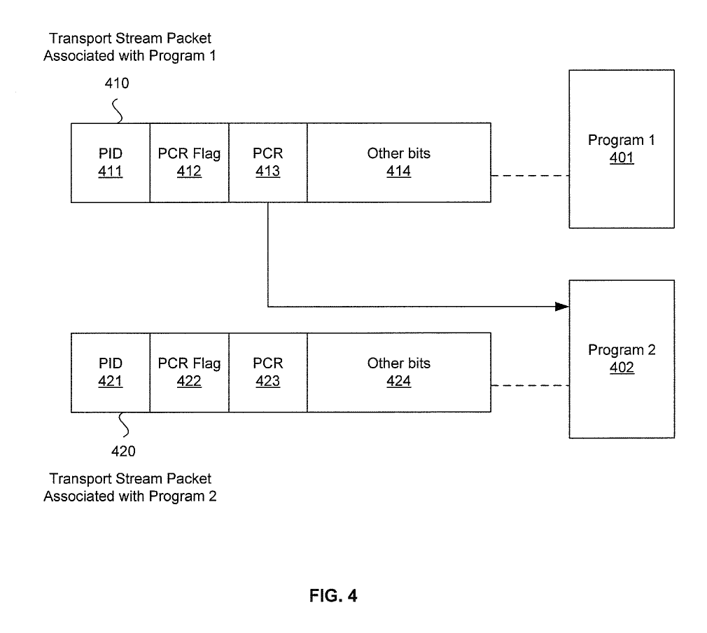

FIG. 4 is a block diagram illustrating an exemplary extraction of a program clock reference (PCR) from a transport stream packet, in accordance with an embodiment of the invention. Referring to FIG. 4, there is shown a program 1 401, a transport stream packet associated with program 1 410, a program 2 402 and a transport stream packet associated with program 2 420. The transport stream packet associated with program 1 410 may comprise a PID 411, a PCR Flag 412, a PCR 413 and other bits 414. The transport stream packet associated with program 2 420 may comprise a PID 421, a PCR flag 422, a PCR 423 and other bits 424.

A transport stream packet, for example, the transport stream packet associated with program 1 410 or the transport stream packet associated with program 2 420 may comprise, for example, 1504 bits (188 bytes). Each packet in a transport stream 120 such as, for example, an audio packet, a video packet or a data packet may be identified by a 13-bit PID, for example, the PID 411 in the transport stream packet associated with program 1 410 or the PID 421 in the transport stream packet associated with program 2 420. A receiver 130 may be operable to extract transport stream packets from an input stream, for example, the transport stream 120 in part by looking for packets identified by the same PID.

The 1-bit PCR flag, for example, the PCR flag 412 in the transport stream packet associated with program 1 410 or the PCR flag 422 in the transport stream packet associated with program 2 420 may be used to indicate whether the transport stream packet comprises a PCR field. In this regard, for example, the 1 value of the PCR flag 412 may mean that the transport stream packet associated with program 1 410 comprises a PCR field. The 1 value of the PCR flag 422 may mean that the transport stream packet associated with program 2 420 comprises a PCR field.

The 42-bit PCR, for example, the PCR 413 in the transport stream packet associated with program 1 410 or the PCR 423 in the transport stream packet associated with program 2 420 may be provided to assist the receiver 130 to recover a locked oscillator or clock such as, in MPEG-2, a 27 MHz oscillator or clock and a system time clock (STC) such as, in MPEG-2, the 90 KHz clock that is derived from the 27 MHz oscillator or clock. The first 33 bits of the PCR 413 or the PCR 423 may be, for example, based on a 90 KHz clock and the last 9 bits may be, for example, based on a 27 MHz oscillator or clock.

The other bits, for example, the other bits 414 in the transport stream packet associated with program 1 410 or the other bits 424 in the transport stream packet associated with program 2 420 may comprise, for example, other adaptation header bits and payload bits.

In an exemplary embodiment of the invention, the receiver 130 may be operable to extract the PCR 413 from the transport stream packet associated with program 1 410 to recover the locked oscillator and STC and process or decode the program 2 (or content 2) 402 using the recovered locked oscillator and STC. In this regard, the program 2 (or content 2) 402 may be, for example, content or a commercial inserted on the program 1 (or content 1) 401, for example, for a period of time.

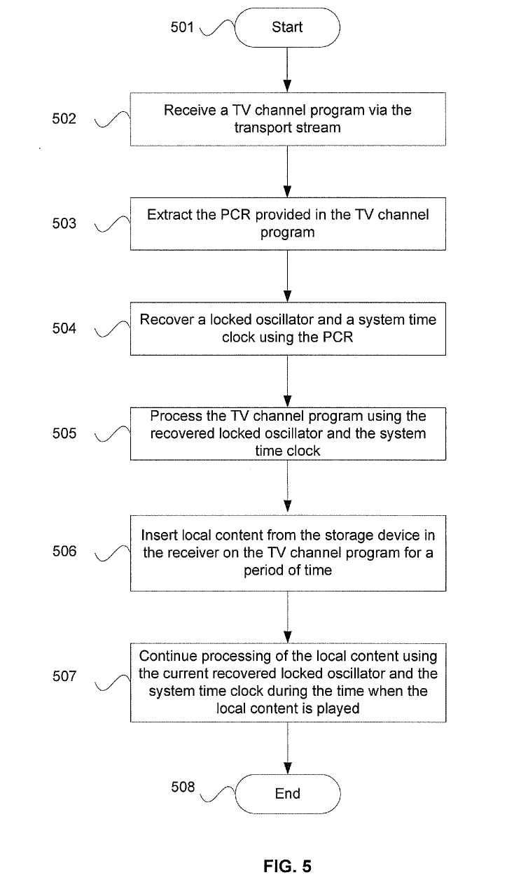

FIG. 5 is a flow chart illustrating exemplary steps for inserting local content on a TV channel program, in accordance with an embodiment of the invention. Referring to FIG. 5, the exemplary steps start at step 501. In step 502, the receiver 200 may be operable to receive a TV channel program via the transport stream 120. In step 503, the receiver 200 may be operable to extract the PCR provided in the received TV channel program. In step 504, the receiver 200 may be operable to recover the locked oscillator and the system time clock using the extracted PCR. In step 505, the receiver 200 may be operable to process or decode the TV channel program using the recovered locked oscillator and the system time clock. In step 506, the receiver 200 may be operable to insert local content from the storage device 240 in the receiver 200 on the TV channel program for a period of time. In step 507, the receiver 200 may be operable to continue processing of the local content using the current recovered locked oscillator and the system time clock during the time when the local content is played. The exemplary steps may proceed to the end step 508.

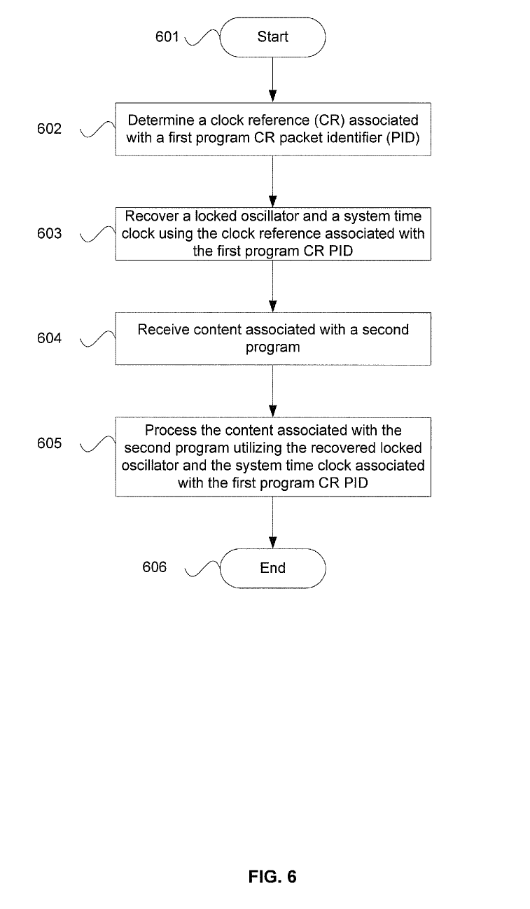

FIG. 6 is a flow chart illustrating exemplary steps for decoupling streams for clock recovery and decoding, in accordance with an embodiment of the invention. Referring to FIG. 6, the exemplary steps start at step 601. In step 602, the receiver 200 may be operable to determine a clock reference (CR) associated with a first program CR packet identifier (PID). In step 603, the receiver 200 may be operable to recover a locked oscillator and a system time clock using the clock reference associated with the first program CR PID. In step 604, the receiver 200 may be operable to receive content associated with a second program. In step 605, the receiver 200 may be operable to process the content associated with the second program utilizing the recovered locked oscillator and the system time clock that are associated with the first program CR PID. The exemplary steps may proceed to the end step 606.

In various embodiments of the invention, a receiver 130, 200 may be operable to determine a clock reference (CR) associated with a first program CR packet identifier (PID) 411, recover a locked oscillator and a system time clock (STC) from the determined clock reference associated with the first program CR packet identifier (PID) 411 and process content associated with a second program 402 utilizing the recovered locked oscillator and the system time clock. In this regard, the receiver 130, 200 may be operable to process content associated with the first program CR PID 411 utilizing the recovered locked oscillator and the system time clock and insert the content associated with the second program 402 on the content associated with the first program CR PID 411. The receiver 200 may be operable to receive the content associated with the second program 402 from a source that is local to the receiver 200. In this regard, the source that is local to the receiver 200 may comprise a local storage 240 within the receiver 200 such as a hard disk or a local storage 240 that is coupled to the receiver 200 such as a flash drive. The receiver 130, 200 may also be operable to receive the content associated with the second program 402 from a source that is remote with respect to the receiver 130, 200. The determined clock reference may comprise a MPEG program clock reference (PCR) 413. The receiver 130 may be operable to extract the clock reference from a MPEG transport stream 120.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for decoupling streams for clock recovery and decoding.

Accordingly, the present invention may be realized in hardware, software, or a combination of hardware and software. The present invention may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing data, the method comprising:
performing by one or more processors and/or circuits in a receiver:
determining a clock reference (CR) associated with a first program CR packet identifier (PID);
recovering a locked oscillator and a system time clock (STC) from said determined clock reference associated with said first program CR packet identifier; and
processing content associated with a second program utilizing said recovered locked oscillator and said system time clock.

2. The method according to claim 1, comprising processing content associated with said first program CR PID utilizing said recovered locked oscillator and said system time clock.

3. The method according to claim 2, comprising inserting said content associated with said second program on said content associated with said first program CR PID.

4. The method according to claim 1, comprising receiving said content associated with said second program from a source that is local to said receiver.

5. The method according to claim 4, wherein said source that is local to said receiver comprises a local storage within said receiver.

6. The method according to claim 4, wherein said source that is local to said receiver comprises a local storage that is coupled to said receiver.

7. The method according to claim 4, wherein said source that is local to said receiver comprises a hard disk and a flash drive.

8. The method according to claim 1, comprising receiving said content associated with said second program from a source that is remote with respect to said receiver.

9. The method according to claim 1, wherein said determined clock reference comprises a MPEG program clock reference (PCR).

10. The method according to claim 1, comprising extracting said clock reference from a MPEG transport stream.

11. A system for processing data, the system comprising:
one or more processors and/or circuits for use in a receiver, wherein said one or more processors and/or circuits are operable to:
determine a clock reference (CR) associated with a first program CR packet identifier (PID);
recover a locked oscillator and a system time clock (STC) from said determined clock reference associated with said first program CR packet identifier; and
process content associated with a second program utilizing said recovered locked oscillator and said system time clock.

12. The system according to claim 11, wherein said one or more processors and/or circuits are operable to process content associated with said first program CR PID utilizing said recovered locked oscillator and said system time clock.

13. The system according to claim 12, wherein said one or more processors and/or circuits are operable to insert said content associated with said second program on said content associated with said first program CR PID.

14. The system according to claim 11, wherein said one or more processors and/or circuits are operable to receive said content associated with said second program from a source that is local to said receiver.

15. The system according to claim 14, wherein said source that is local to said receiver comprises a local storage within said receiver.

16. The system according to claim 14, wherein said source that is local to said receiver comprises a local storage that is coupled to said receiver.

17. The system according to claim 14, wherein said source that is local to said receiver comprises a hard disk and a flash drive.

18. The system according to claim 11, wherein said one or more processors and/or circuits are operable to receive said content associated with said second program from a source that is remote with respect to said receiver.

19. The system according to claim 11, wherein said determined clock reference comprises a MPEG program clock reference (PCR).

20. The system according to claim 11, wherein said one or more processors and/or circuits are operable to extract said clock reference from a MPEG transport stream.
